(19) United States
(12) Patent Application Publication
(10) Pub. No.: US 2022/0256080 A1
(43) Pub. Date: Aug. 11, 2022

(54) PANORAMIC PHOTOGRAPHING DEVICE AND METHOD APPLIED TO SAME

(71) Applicant: TRIPLE WIN TECHNOLOGY(SHENZHEN) CO.LTD., Shenzhen (CN)

(72) Inventors: WEN-XUE LIAO, Shenzhen (CN); SHANG-FENG WU, New Taipei (TW)

(21) Appl. No.: 17/527,317

(22) Filed: Nov. 16, 2021

(30) Foreign Application Priority Data
Feb. 5, 2021 (CN) 202110162689.8

(51) Int. Cl. H04N 5/232; H04N 5/225; G03B 37/04

(52) U.S. Cl. CPC H04N 5/23238; H04N 5/2256; H04N 5/2259; G03B 37/04; H04N 5/23293; H04N 5/23229; H04N 5/2258

(57) ABSTRACT

A hand-held photographing device capable of outputting panoramic images includes a screen, a plurality of camera modules, and a control device. The screen is curved and extends to cover multiple surfaces of the device. The camera modules are located on different surfaces of the device, and the camera modules which are on the same surfaces of the panoramic photographing device as the screen are covered by the screen. Each camera module includes a large wide-angle camera. The control device issues instructions to the camera modules. Images from different directions are collected and the multiple images are used to synthesize a panoramic image for storage or display. The present disclosure also provides a panoramic image photographing method, which is applied to a panoramic photographing device.

### TECHNICAL FIELD

The present disclosure relates to imaging, a photographing device and method to obtain panoramic images.

### BACKGROUND

A conventional method to obtain panoramic images is to click the shutter key, and then move the image-capture device slowly and smoothly along the horizontal direction according to the instructions on the screen.

In the process of shooting, stability of the device is essential, and it is difficult to achieve, particularly with hand-held devices. There are professional panoramic camera devices in the industry, which can directly obtain panoramic images, but most of these devices are composed of several large wide-angle camera modules, making portability a problem.

Therefore, improvement is desired.

### BRIEF DESCRIPTION OF THE DRAWINGS

FIG. 1A is a front stereoscopic schematic diagram of a panoramic photographing device according to an embodiment of the present disclosure.

FIG. 1B is a stereoscopic schematic diagram of the rear of a panoramic photographing device according to an embodiment of the present disclosure.

FIG. 2 is a sectional view along line II-II of FIG. 1A.

FIG. 3 is a sectional view along line of FIG. 1A.

FIG. 4 is a schematic diagram of the horizontal shooting range of each camera module of the panoramic photographing device according to the embodiment of the present disclosure.

FIG. 5 is a schematic diagram of the photosensitive element placement mode of the panoramic photographing device according to the embodiment of the present disclosure.

FIG. 6 is a flowchart of a panoramic image photographing method according to an embodiment of the present disclosure.

### DETAILED DESCRIPTION

The technical solutions in the embodiments of the present disclosure will be described in conjunction with the accompanying drawings in the embodiments of the present disclosure. Obviously, the described embodiments are part of the embodiments of the present disclosure, not all of them. Based on the embodiments of the present disclosure, all other embodiments obtained by those of ordinary skill in the art without creative work shall fall within the protection scope of the present disclosure.

The present disclosure provides a panoramic photographing device, the panoramic photographing device includes a plurality of camera modules, and each camera module is located on different surfaces of the panoramic photographing device. During shooting, the plurality of camera modules can simultaneously collect a plurality of images in different directions, and then synthesize the plurality of images into a panoramic image. In the embodiment, the panoramic photographing device is an intelligent mobile terminal equipped with the camera module, such as a mobile phone or a tablet computer.

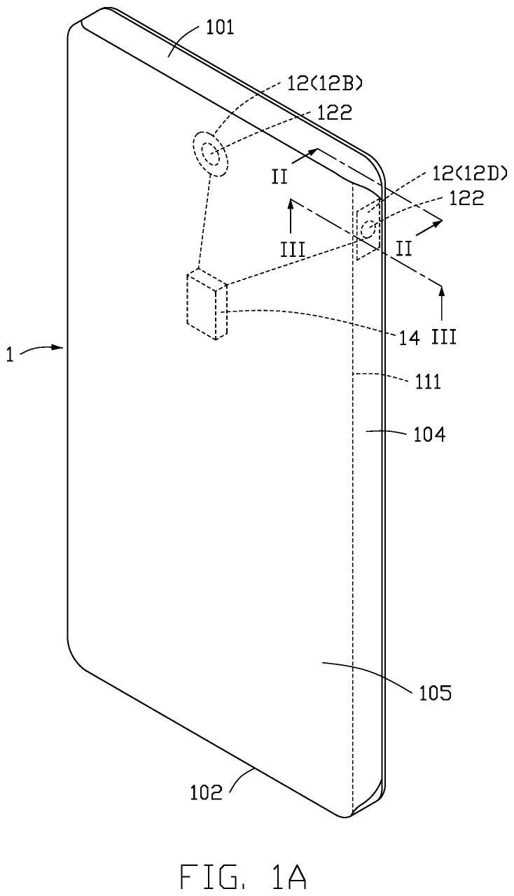

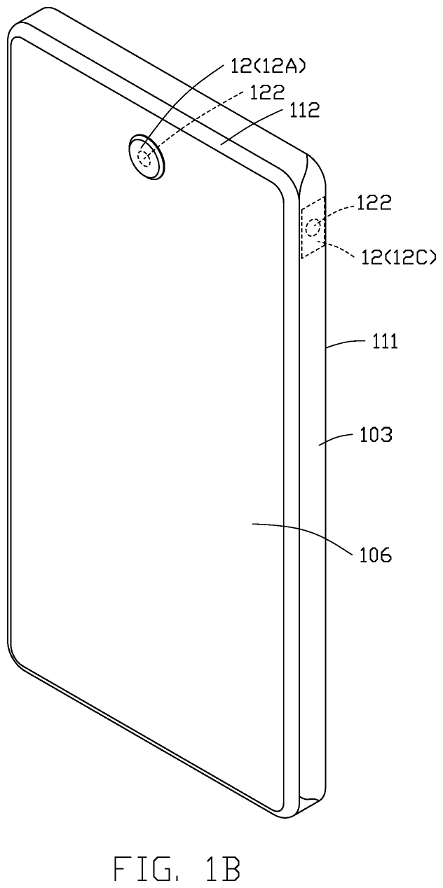

FIGS. 1A and 1B show the panoramic photographing device 1 of the present disclosure.

The panoramic photographing device 1 includes six surfaces, the six surfaces can include an upper surface 101, a lower surface 102, a left surface 103, a right surface 104, a front surface 105, and a back surface 106. The description of the following embodiments is based on the user holding the panoramic photographing device 1 in his hand, and the front surface 105 faces the user, the left surface 103 faces the left side of the user, and the right surface 104 faces the right side of the user. The direction from the left surface 103 to the right surface 104 is defined as the horizontal direction, and the direction from the upper surface 101 to the lower surface 102 is defined as the vertical direction.

In the embodiment, the panoramic photographing device 1 includes a screen 111, a housing 112, a plurality of camera modules 12, and a control device 14. The screen 111 is a curved screen and extends to cover a plurality of faces of the panoramic photographing device 1. The camera modules 12 are located on the surfaces of the panoramic photographing device 1, and the camera module 12 on the same surface of the panoramic photographing device 1 as the screen 111 is covered by the screen 111. Each of the camera modules 12 includes a large wide-angle camera 122 for panoramic viewing, so that the field angles of the plurality of camera modules 12 can be superimposed to form a viewing range greater than 360°. The control device 14 is used to send instructions to the plurality of camera modules 12, so that the plurality of camera modules 12 respectively collect a plurality of images in different directions, which are used to synthesize panoramic images and display them on the screen 111.

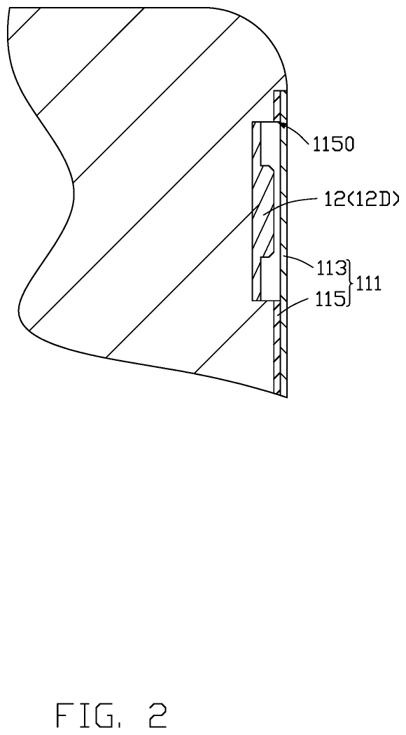

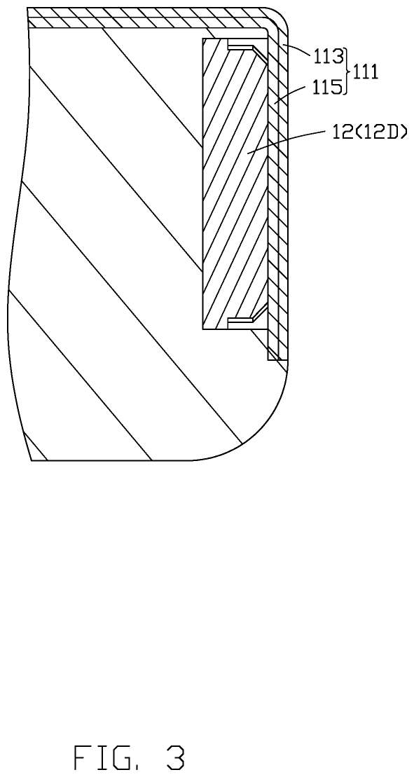

In one embodiment, the coverage of the screen 111 may include a front surface 105, a left side 103 and a right surface 104 of the panoramic photographing device 1. In another embodiment, the left surface 103 and the right surface 104 may include a part of the housing. At this time, the left surface 103 and the right surface 104 in the following description may represent only the part of the screen 111 they contain. Referring to FIG. 2 and FIG. 3, the screen 111 includes a cover plate 113 and a functional layer 115 stacked with the cover plate 113. The functional layer 115 can include a display module and a touch module to realize the display and touch functions of the screen 111.

In the embodiment, the panoramic photographing device 1 includes four camera modules 12, which are camera module 12A, camera module 12B, camera module 12C, and camera module 12D. The camera module 12A is located at the back surface 106 of the panoramic photographing device 1, the camera module 12B is located at the front surface 105, the camera module 12C is located at the left surface 103, and the camera module 12D is located at the right surface 104.

Referring to FIG. 1B, the housing 112 is an opaque material, so a hole position needs to be reserved on the housing 112 to set the camera module 12A. The camera module 12a is embedded in a hole reserved on the housing 112. The camera module 12A is partially outside the housing 112 and partially inside the housing 112. In the embodiment, when the housing 112 is transparent, the camera module 12A can also be arranged on the inner side of the housing 112 without setting a hole position for the camera module 12A on the housing 112.

Referring again to FIG. 1A and FIG. 1B, the camera module 12B is located at the front surface 105 of the panoramic photographing device 1, the camera module 12C is located at the left surface 103 of the panoramic photographing device 1, and the camera module 12D is located at the right surface 104 of the panoramic photographing device 1. In the embodiment, since the cover plate 113 of the screen 111 (including the front surface 105, the left surface 103 and the right surface 104) is transparent and does not affect the shooting of the camera module 12B, it is not necessary to leave holes on the cover plate 113 for the camera module 12B, the camera module 12C, and the camera module 12D to pass through.

In the embodiment, the camera module 12B, the camera module 12C, and the camera module 12D covered by the screen 111 occupy a part of the screen area. For the occupied screen area, there can be a variety of solutions, including but not limited to aperture zone screen and off-screen camera technology. In one embodiment, the screen 111 can be an aperture zone screen. The aperture zone screen refers to the functional layer 115 leaving a light transmitting hole position in the area corresponding to each camera module 12 covered by the screen 111, that is, a through hole 1150 is opened (refer to FIG. 2), so as to enable shooting. The cover plate 113 is transparent in the area where the camera module 12 is located, and there is no need to reserve a hole. In another embodiment, at least one of the camera module 12B, the camera module 12C, and the camera module 12D covered by the screen 111 may be arranged on the side of the functional layer 115 away from the cover plate 113 (also known as the off screen camera module). When the camera module 12B, the camera module 12C and the camera module 12D are not used, the screen 111 normally displays images corresponding to the areas of the camera module 12B, the camera module 12C, and the camera module 12D. When the camera module 12B, the camera module 12C, and the camera module 12D are turned on, the area of the screen 111 corresponding to the camera module 12B, the camera module 12C, and the camera module 12D can be transparent, which does not affect the image shooting by the camera module 12B, the camera module 12C, and the camera module 12D.

For example, referring to FIG. 2, the screen 111 is an aperture zone screen, in which the functional layer 115 leaves a transparent through hole 1150 in the area of the camera module 12D, and the camera module 12D can shoot through the cover plate 113. Referring to FIG. 3, the camera module 12D is arranged on the side of the functional layer 115 away from the cover plate 113 and is covered by the screen 111. When the camera module 12D is opened, the cover plate 113 of the screen 111 and the area of the functional layer 115 corresponding to the camera module 12D can transmit light without affecting the image shooting of the camera module 12D.

In the embodiment, each camera module 12 may refer to all components realizing the photographing function on a certain surface of the panoramic photographing device 1. In order to realize the panoramic shooting function, each camera module 12 includes a large wide-angle camera 122. One or more of the camera modules 12 may also include, for example, one or any combination of a macro camera, a near/far view camera, and an ultra wide-angle camera. One of or any combination of the macro camera, near/far view camera and ultra wide-angle camera can also be used for panoramic shooting to improve the effect of the captured image. The macro camera, near/far view camera and ultra wide-angle camera refer to cameras that can improve the quality of panoramic image, but are not limited to these cameras.

For example, referring to FIG. 1B, the camera module 12A includes at least one large wide-angle camera 122. In one embodiment, the camera module 12A may be a camera module including a wide-angle camera 122, a macro camera, a near/far view camera, and other cameras. In another embodiment, the camera module 12A may also be a camera module containing only one large wide-angle camera 122.

In the embodiment, the field-of-view angle of each camera module 12 is greater than or equal to 120°, and the field angles of the four camera modules 12 can be superimposed to form a field angle greater than 360° in the horizontal direction. The superposition of the viewing range of all the camera modules 12 can cover all the shooting targets in the horizontal direction. The viewing range refers to the extent of a scene which appears in the image captured by each camera module 12.

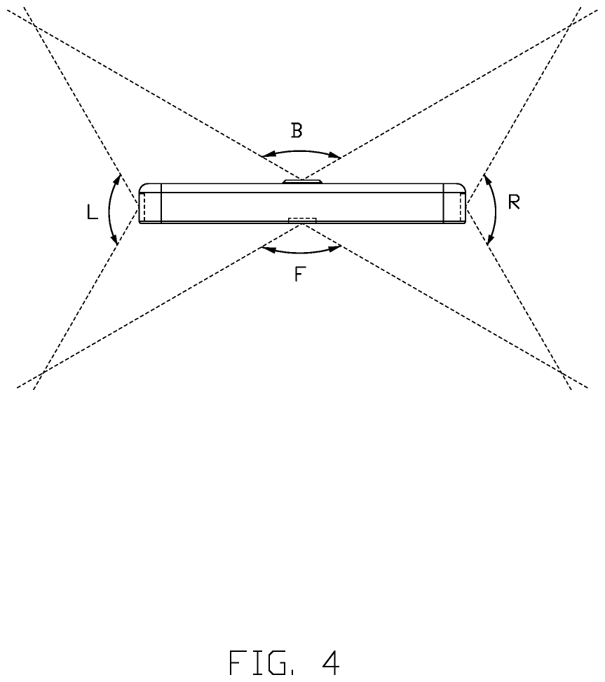

For example, referring to FIG. 4, the view range B is the view range of the camera module 12A, the view range f is the view range of the camera module 12B, the view range L is the view range of the camera module 12C, and the view range R is the view range of the camera module 12D. There is an overlapping area in the viewing range covered by each camera module 12, and the sum of the field-of-view angles in the horizontal direction of each camera module 12 is greater than 360°, which can meet the needs of photographing panoramic images. That is, the images captured by each camera module 12 can be synthesized into a panoramic image, and a full 360 degrees of view and more can be captured by camera module 12.

In the embodiment, each camera module 12 includes a photosensitive element (not shown). The photosensitive elements of the camera module 12 can be placed in different ways, which can meet the needs of photographing panoramic images, that is, the sum of the coverage of the field angle in the horizontal direction is greater than 360°.

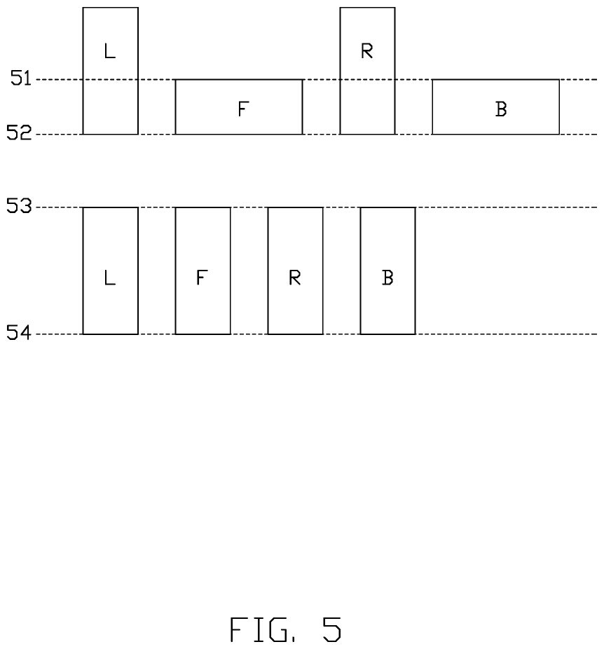

For example, referring to FIG. 5, the viewfinder boundary line 51, the viewfinder boundary line 52, the viewfinder boundary line 53 and the viewfinder boundary line 54 represent the viewfinder boundary line of the panoramic image in the vertical direction. In one embodiment, the arrangement of each photosensitive element is different, and the viewfinder range L and the viewfinder range R exceed the viewfinder range F and viewfinder range B in the vertical direction. In the process of synthesizing the panoramic image, in order to ensure the integrity of the image, the viewfinder boundary line 51 cannot exceed the viewfinder range B and viewfinder range F. The parts beyond the viewfinder boundary line do not participate in the synthesis of the panoramic image after the image is captured, as they belong to the redundant part. In another embodiment, the arrangement of each photosensitive element is the same, and the viewfinder boundary line 53 and the viewfinder boundary line 54 can be set to the upper and lower boundaries common to all viewfinder ranges at most.

In the embodiment, the panoramic image is formed by splicing together a plurality of images taken one by one by each adjacent camera module 12. In FIG. 4, there are overlapping areas in the viewfinder range of each camera module 12, so objects in the captured scene may appear repeatedly on a plurality of images. The repeated parts can be eliminated by post-processing technology, and the eliminated part also belongs to redundant part.

In the embodiment, the optical axis of the large wide-angle camera 122 in each camera module 12 is in the same plane, and the plane is parallel to the upper surface 101. In this way, the image centers of multiple images collected by each camera module 12 are in the same plane, and there is no need to adjust the position in the vertical direction during splicing. If the optical axis of the large wide-angle camera 122 in each camera module 12 is not in the same plane, the synthesis of the panoramic image also needs to include the position calibration in the vertical direction. When stitching the above multiple images, it is necessary to adjust the position of the multiple images in the vertical direction, and cut the part that cannot be spliced with other images in the vertical direction due to the adjustment of the position, so as to reduce the viewfinder range of the panoramic image. Therefore, by setting the optical axis of the large wide-angle camera 122 in each camera module 12 in the same plane, the solution of the present disclosure simplifies the image stitching process and avoids reducing the viewfinder range.

In the embodiment, the installation position of the large wide-angle camera 122 in each camera module 12 in the vertical direction is variable. For example, referring to FIG. 1A, in one embodiment, the large wide-angle camera 122 in the camera module 12B may be located anywhere near the upper surface 101 of the panoramic photographing device 1. In another embodiment, the large wide-angle camera 122 in the camera module 12B may be located anywhere near the lower surface 102. When determining the vertical installation position of the large wide-angle camera 122 in one camera module 12, the large wide-angle camera 122 in other camera modules 12 should also confirm the vertical installation position, so as to ensure that the optical axis of the large wide-angle camera 122 in all camera modules 12 is in the same horizontal plane.

In the embodiment, when the optical axis of the large wide-angle camera 122 in each camera module 12 is on the same horizontal plane, the relative position in the horizontal direction is variable. For example, referring to FIG. 1A and FIG. 1B, the camera module 12A may be installed at any position of the horizontal line intersecting the horizontal plane and the back surface 106. The camera module 12B can also be installed at any position of the horizontal line where the horizontal plane intersects the front surface 105. The position in the horizontal direction of the camera module 12A is not related to the horizontal position in the direction of the camera module 12B.

Referring again to FIG. 1A, the control device 14 is used to control the panoramic photographing device 1 to shoot. The control device 14 may be a control device built into the panoramic photographing device 1. The control device 14 may include all operation settings conducive to realizing the shooting function, such as shutter, zoom function, setting function of delayed shooting, etc. In the shooting process, the position of the panoramic photographing device 1 does not change, and the control device 14 sends a command to each camera module 12 to make each camera module 12 shoot at the same time, and then synthesizes the images captured by each camera module 12 into panoramic images.

In the embodiment, the enabling state of each camera module 12 can be selected, and one or two or three or four camera modules 12 can be turned on. Before starting to take panoramic photos, the camera modules 12 can be selected by the control device 14, or the enabled state of each camera module 12 can be viewed by the control device 14.

In the embodiment, before shooting, the panoramic photographing device 1 can be set by the control device 14 to improve the effect of the panoramic image. For example, the control device 14 can enable the camera in the camera module 12, only enable the large wide-angle camera 122 in the camera module 12, or simultaneously enable one or any combination of macro camera, near/far view camera and ultra wide-angle camera in the camera module 12.

In the embodiment, after the control device 14 enables the camera module 12, the image within the viewfinder range of each camera module 12 can be displayed on the screen 111 in real time, so that the user can preview the panoramic image and adjust the viewfinder range when holding the panoramic photographing device 1.

In the embodiment, the camera module 12 can be matched with an illuminating device to take photos at night. This may be an electronic flash lamp or other tool that helps to improve the field illumination within the viewfinder range. Before starting to shoot a panoramic image, the activation state of the illumination device can be set by the control device 14.

In the embodiment, when the user uses the panoramic photographing device 1 to capture a panoramic image, the user sends a photographing command through the control device 14. The panoramic photographing device 1 receives the photographing instruction, the panoramic photographing device 1 determines the opened state of each camera module 12, controls the opened camera module 12 to shoot, obtains the image photographed by each camera module 12, splices and synthesizes the image, and displays the synthesized panoramic image on the screen 111. In the shooting process, the user only needs to execute the operation of sending shooting instructions to obtain the panoramic image. Other processes are automatically completed by the panoramic photographing device 1 without moving the panoramic photographing device 1, which is conducive to improving the shooting accuracy of the panoramic image.

In the embodiment, the panoramic photographing device 1 may include a plurality of other components constituting an intelligent mobile terminal, such as various communication elements arranged inside the panoramic photographing device 1 and/or operation keys, SIM card slots, headphone holes, charging jacks, microphones, speakers, etc. arranged on all sides of the panoramic photographing device 1, which will not be described in the present disclosure.

In the embodiment, the panoramic photographing device 1 is an intelligent mobile terminal with a curved screen, and its characteristics should meet the characteristics of the intelligent mobile terminal. Therefore, portability is a major requirement of the intelligent mobile terminal. For example, the panoramic photographing device 1 can perform panoramic photographing when the user holds it with one hand.

The embodiment of the present disclosure also provides a panoramic image photographing method, which is applied to the panoramic photographing device 1 in the embodiment.

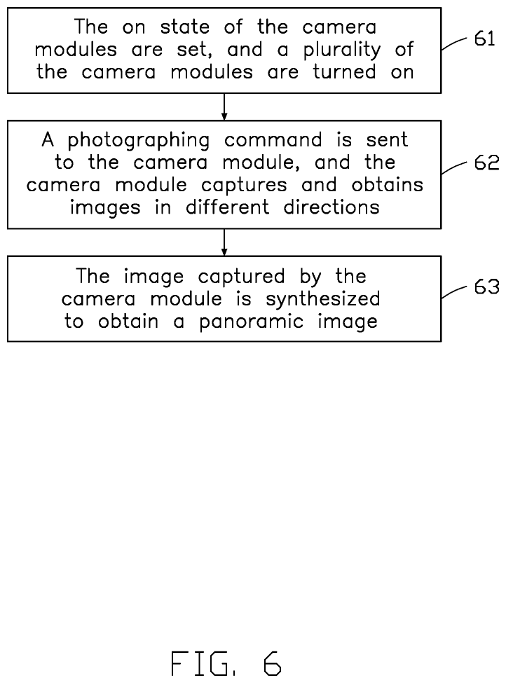

FIG. 6 is a flowchart depicting an embodiment of a panoramic image photographing method. The method is provided by way of example, as there are a variety of ways to carry out the method.

Each block shown in FIG. 6 represents one or more processes, methods, or subroutines, carried out in the example method. Furthermore, the illustrated order of blocks is illustrative only and the order of the blocks can change. Additional blocks can be added or fewer blocks may be utilized, without departing from the present disclosure. The example method can begin at block 61.

At block 61, the on state of the camera modules 12 are set, and a plurality of the camera modules 12 are turned on.

In one embodiment, four camera modules 12 can be turned on. For example, the camera module 12A on the back surface 106 of the panoramic photographing device 1 is turned on, the camera module 12B on the front surface 105 of the panoramic photographing device 1 is turned on, the camera module 12C on the left surface 103 of the panoramic photographing device 1 is turned on, and the camera module 12D on the right surface 104 of the panoramic photographing device 1 is turned on.

At block 62, a photographing command is sent to the camera modules 12, and the camera modules 12 captures and obtains images in different directions.

At block 63, the image captured by the camera module 12 is synthesized to obtain a panoramic image.

In one embodiment, each camera module 12 also includes one or any combination of macro camera, near/far view camera and ultra wide-angle camera. The panoramic image photographing method also includes setting the on state of one or any combination of the large wide-angle camera 122, the macro camera, the near/far view camera and the ultra wide-angle camera in the opened camera module 12 before block 62.

In one embodiment, block 63 also includes merging the overlapping image areas captured by different camera modules 12.

Those of ordinary skill in the art should realize that the above embodiments are only used to illustrate the present disclosure, but not to limit the present disclosure. As long as they are within the essential spirit of the present disclosure, the above embodiments are appropriately made. Changes and changes fall within the scope of protection of the present disclosure.

What is claimed is:

1. A panoramic photographing device comprising:
a screen extending to cover a plurality of surfaces of the panoramic photographing device;
a plurality of camera modules respectively locating on the plurality of surfaces of the panoramic photographing device; and
a control device issuing instructions to the plurality of camera modules, wherein:
the screen is a curved screen,
the plurality of camera modules and the screen are on same surface of the panoramic photographing device, and the camera module is covered by the screen, each of the plurality of camera modules comprises a large wide-angle camera for panoramic image viewfinder, and field angles of the plurality of camera modules are superimposed to form a viewfinder range greater than 360°, and
the plurality of camera modules respectively collect a plurality of images in different directions, and the plurality of images are used to synthesize panoramic images and display them on the screen.

2. The panoramic photographing device of claim 1, wherein the screen comprises:
a cover plate and a functional layer stacked with the cover plate;
the functional layer is used to display the synthesized panoramic images; and
the functional layer is provided with a through hole corresponding to each camera module covered by the screen.

3. The panoramic photographing device of claim 1, wherein:
the screen comprises a cover plate and a functional layer stacked with the cover plate:
the functional layer is used to display the synthesized panoramic images; and
each of the plurality of camera modules covered by the screen is located on a side of the functional layer away from the cover plate.

4. The panoramic photographing device of claim 1, wherein:
the plurality of camera modules comprises four camera modules;
each of the four camera modules comprises one or any combination of a macro camera, a near/far view camera, and an ultra wide-angle camera; and
one or any combination of the macro camera, the near/far view and the ultra wide-angle camera is selectively used for panoramic image framing together with the large wide-angle camera.

5. The panoramic photographing device of claim 1, wherein:
an optical axis of the large wide-angle camera of the camera modules is located on a same plane; and
the plane is at least parallel to one plane of the panoramic photographing device.

6. The panoramic photographing device of claim 1, wherein:
the plurality of camera modules comprises a lighting tool; and
the lighting tool is used to improve exposure of the plurality of the camera modules when shooting.

7. The panoramic photographing device of claim 1, wherein a field of view angle of each of the plurality of camera modules is greater than or equal to 120°.

8. A panoramic photographing device comprising:
a screen extending to cover a plurality of surfaces of the panoramic photographing device;
a plurality of camera modules respectively locating on the plurality of surfaces of the panoramic photographing device; and
a control device issuing instructions to the plurality of camera modules, wherein:
the screen is a curved screen,
the plurality of camera modules and the screen are on same surface of the panoramic photographing device, and each of the plurality of camera modules is covered by the screen, each of the plurality of camera modules comprises a large wide-angle camera for panoramic image viewfinder, and field angles of the plurality of camera modules are superimposed to form a viewfinder range greater than 360°,
the plurality of camera modules respectively collect a plurality of images in different directions, and the plurality of images are used to synthesize panoramic images and display them on the screen, and
an optical axis of the large wide-angle camera of the camera modules is located on a plane at least parallel to one plane of the panoramic photographing device.

9. The panoramic photographing device of claim 8, wherein:
the screen comprises a cover plate and a functional layer stacked with the cover plate;
the functional layer is used to display the synthesized panoramic images; and
the functional layer is provided with a through hole corresponding to each camera module covered by the screen.

10. The panoramic photographing device of claim 8, wherein:
the screen comprises a cover plate and a functional layer stacked with the cover plate;
the functional layer is used to display the images; and
each of the plurality of camera modules covered by the screen is located on a side of the functional layer away from the cover plate.

11. The panoramic photographing device of claim 8, wherein:
the plurality of camera modules comprises four camera modules;
each of the four camera modules comprises one or any combination of a macro camera, a near/far view camera, and an ultra wide-angle camera; and
one or any combination of the macro camera, the near/far view and the ultra wide-angle camera is selectively used for panoramic image framing together with the large wide-angle camera.

12. The panoramic photographing device of claim 8, wherein:
the plurality of camera modules comprises a lighting tool; and
the lighting tool is used to improve exposure of the plurality of the camera modules when shooting.

13. The panoramic photographing device of claim 8, wherein a field of view angle of each of the plurality of camera modules is greater than or equal to 120°.

14. A panoramic photographing method applied to a panoramic photographing device, the panoramic photographing device comprising a plurality of camera modules, and each camera module comprising a large wide-angle camera, and the panoramic image photographing method comprising:
setting on-state of the camera module, wherein a plurality of the camera modules are turned on;
sending a shooting command to the camera modules, and the at least two camera modules capture and obtain images in different directions; and
synthesizing and processing the image captured by the camera modules to obtain a panoramic image.

15. The panoramic photographing method of claim 14, wherein each camera module comprises one or any combination of a macro camera, a near/far view camera, and an ultra wide-angle camera, the panoramic photographing method further comprising:
setting on-state of one or any combination of the large wide-angle camera, the macro camera, the near/far view camera, and the ultra wide-angle camera in the on-stated camera module.

16. The panoramic photographing method of claim 14, further comprising:
merging overlapping image areas captured by the camera modules.
